(19) United States
(12) Patent Application Publication
(10) Pub. No.: US 2011/0225778 A1
(43) Pub. Date: Sep. 22, 2011

(54) INTERIOR TRIM SEALING FASTENER

(75) Inventors: Daniel J. LUBERA, Macomb, MI (US); Jacob A. SIUDYM, II, Emmett, MI (US)

(73) Assignee: NEWFREY LLC, Newark, DE (US)

(21) Appl. No.: 12/765,531

(22) Filed: Apr. 22, 2010

Related U.S. Application Data
(60) Provisional application No. 61/315,239, filed on Mar. 18, 2010.

(51) Int. Cl. B60R 13/02

(52) U.S. Cl. 24/297; 24/289

(57) ABSTRACT

A fastener with a base part and a pair of arms connected to the base part. The base part includes a wide portion and a body portion which is narrower than the wide portion and the body portion has a first end at the wide portion and extends from the wide portion and terminates at a second end. The second end of the body part includes an insertion opening, the arms including an insertion portion which is inserted into the insertion opening and connect the arms to the body portion. The arms also an angled portion, the angled portion extending at an angle from the insertion portion, towards the wide portion and outwardly from the body portion. The arms additionally include a concave portion adjacent to the angled portion and further extending toward the wide portion, a peak being defined between the angled portion and the concave portion.

### BACKGROUND OF THE INVENTION

1. Field of the Invention

The present invention relates to a trim sealing fastener and assembly for securing two or more parts together and, more particularly, for fastening trim to a vehicle body part.

2. Description of the Related Art

There are various related art trim fasteners for attaching two parts together. However, in fields such as the automotive industry, there is continuous demand for improved performance of such fastener parts to attach, for example, a trim part to an automotive body panel.

In such an application, it can be beneficial for the fastener to be removable from the body panel to allow for servicing or replacement of parts. Additionally, it is often desired that the insertion force be relatively low as compared to the extraction force. This allows for the fastener to easily be inserted into the panel to form the assembly, but resistant to accidental disassembly. Furthermore, it can also be beneficial for the extraction and insertion forces to be relatively stable over multiple insertions and extractions, which allows the fastener to last through several services.

It is desirable to provide a fastener with a stable structure so that consistent insertion and extraction forces can be achieved.

### SUMMARY OF THE INVENTION

According to one aspect of the invention, there is a fastener including a base part and a pair of arms connected to the base part. The base part includes a wide portion and a body portion which is narrower than the wide portion. The body portion has a first end at the wide portion and extends from the wide portion and terminates at a second end. The second end of the body part includes an insertion opening. The arms including an insertion portion which is inserted into the insertion opening and connect the arms to the body portion. The arms further comprising an angled portion, the angled portion extending at an angle from the insertion portion, towards the wide portion and outwardly from the body portion. The arms additionally include a concave portion adjacent to the angled portion and further extending toward the wide portion, a peak being defined between the angled portion and the concave portion.

The body portion may further include a cutout extending perpendicular to the opening, the arms may further include tabs at the insertion portion and the tabs extend into the cutout to secure the arms to the base part.

Insertion portions of the arms may further include knobs which create portions of increased width and the knobs may have a frictional fit with the body portion.

The wide portion may have a concave shape.

The base part may further include a connection portion and a spacer spacing the side portion from the connection portion, the spacer being narrower than the wide portion and the connection portion.

The fastener may further comprise a panel secured between the arms and the wide portion of the base part and a connecting part connected to the connection portion of the base part.

The connection portion and the connecting part may be connected in a doghouse configuration.

The arms may be made of metal and the base part may be made of plastic.

The base part may further include a recess which lies along the same axis as the insertion opening and is located at an opposite side of the cutout with respect to the insertion opening and ends of the insertion portions may be located in the recess.

According to another aspect of the invention, there is a fastener including a base part and a pair of arms, wherein the base part includes a connection part; a spacer portion extending downwardly from the connection part, the spacer portion being narrower than the connection part; a concave disk at a bottom end of the spacer, the concave disk being wider than the spacer; and a body portion extending downwardly from the umbrella, the body portion comprising a pair of side rails and a center portion and including an opening at its bottom end, the body portion further comprising a cutout in a direction perpendicular to the downward direction. Each of the arms includes an insertion portion inserted into the opening, an angled portion extending from the insertion portion at an angle towards the concave disk and outwardly from the body portion, and a concave portion adjacent to the angled portion and closer to the concave disk than the angled portion; a peak being defined between the angled portion and the concave portion.

The insertion portion of each arm may include a tab which extends into the cutout and prevents removal of the arms from the base part.

The insertion portion of each arm may further include knobs which create portions of increased width and create a friction fit with the body portion of the base part.

The base part may be made of plastic and the arms may be made of metal.

The cutout may be perpendicular to the opening.

The fastener may further include a panel secured between the concave portion of the arms and the concave disk portion of the base part.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating an exemplary embodiment of a fastener assembly of the present invention;

FIG. 2 is a perspective view of a fastener according an exemplary embodiment of the present invention;

FIG. 3 is a side view of the fastener;

FIG. 4 is a front view of the fastener;

FIG. 5 is a perspective view of a base part of the fastener;

FIG. 6 is a front view of the base part of the fastener

FIG. 7 is a perspective view of an arm of the fastener;

FIG. 8 is a cross-sectional view taken through line --I-- of FIG. 3;

FIG. 9 is a cross-sectional view taken through line --II-- in FIG. 4, and including a panel;

### DETAILED DESCRIPTION OF EXEMPLARY EMBODIMENTS OF THE INVENTION

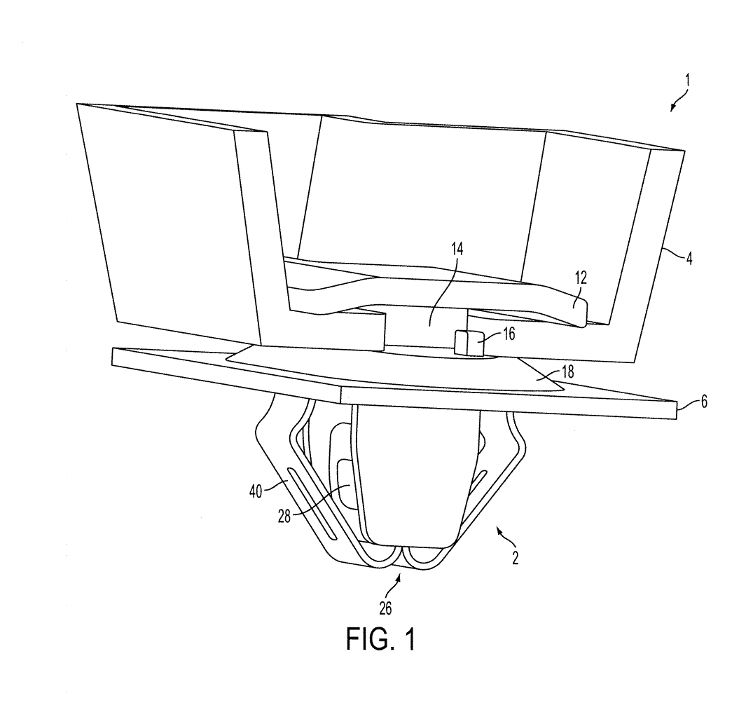

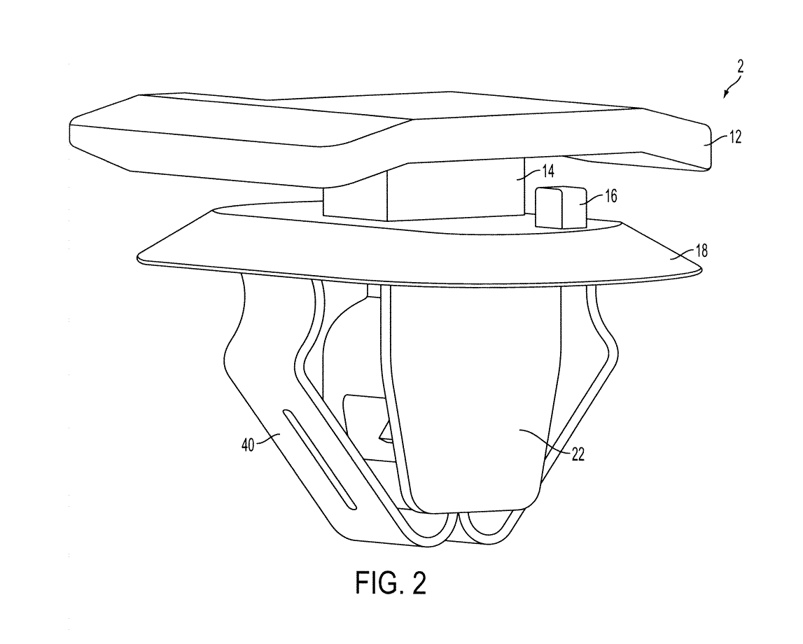

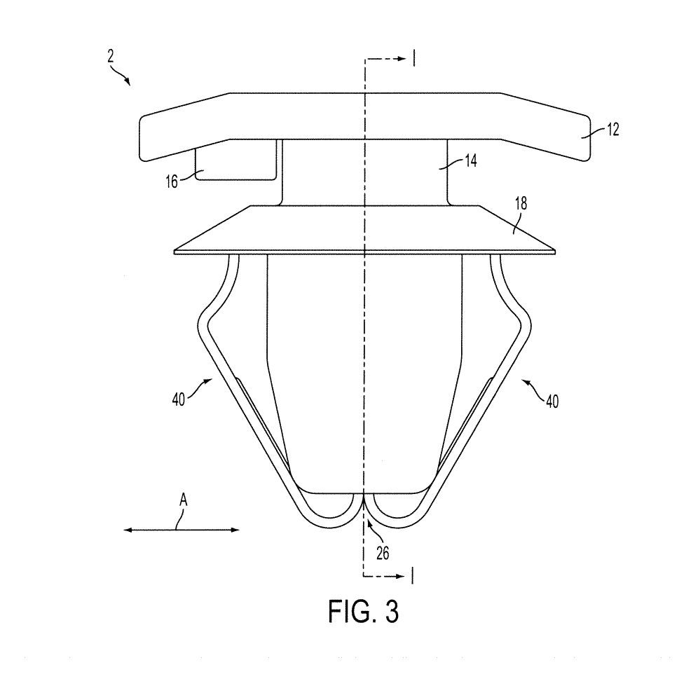

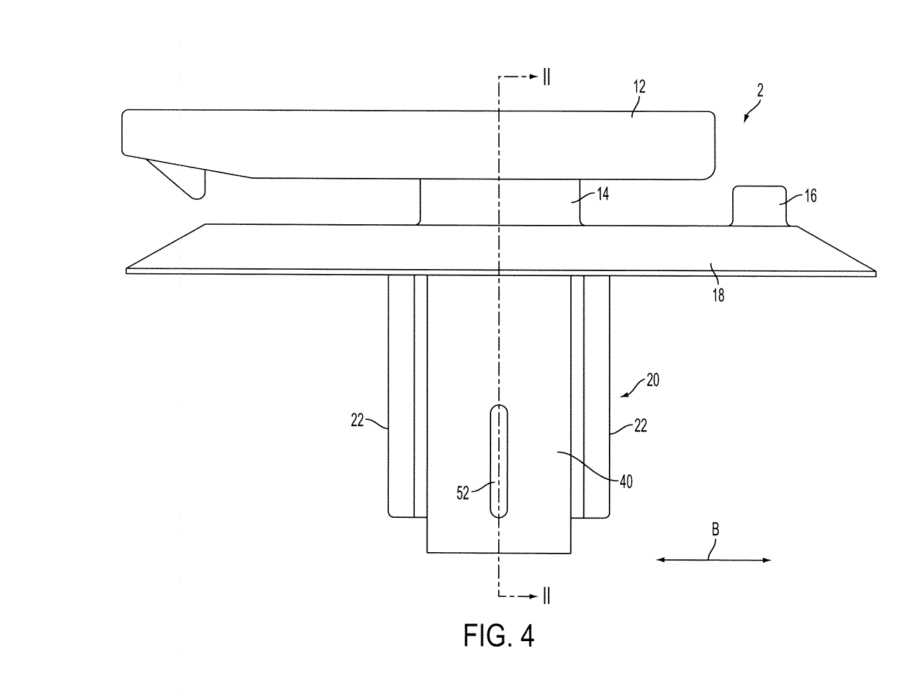

A fastener assembly 1 according to an exemplary embodiment of the invention will now be described in greater detail with reference to the accompanying drawings. FIG. 1 is a perspective view of an exemplary embodiment of a fastener assembly including a trim fastener 2, which connects a first part (doghouse 4) to a second part (panel 6). FIGS. 2-4 are various views of the fastener 2, with FIG. 2 being a perspective view, FIG. 3 showing a side view and FIG. 4 showing a front view.

The fastener according to the exemplary embodiment of the present invention may be used as a trim fastener to fasten trim (first part 4) to a vehicle body panel (second part 6). As shown in FIG. 1, the panel 6 is secured between the arms 40 and a concave disk 18 of the fastener 2. The panel 6 is slidable over the arms 40 to secure it onto the fastener. The panel includes a hole, not shown, through which a bottom of the fastener 2 can be slid. As the fastener 2 is slid into the panel 6 (or the panel 6 is moved onto the fastener), the panel 6 compresses the arms 40 to fit the hole. Then, when the panel 6 passes the peak 47 of the arms 40, the arms 40 spring back outwardly. In this manner, the fastener 2 is firmly held on the panel 6. In the exemplary embodiment shown in FIG. 1, the panel 6 is held between ends of the arms 40 and the concave disk 18. However, the hole of the panel 6 may overlap with the concave portion 46 of the arms 40 so that the panel 6 is held somewhere between the peak 47 or concave portion 46 of the arms 40 and the concave disk 18.

The fastener 2 also includes a connection part/flange 12 which slides into the doghouse 4 to secure the doghouse 4 to the fastener. By holding the panel 6 in place and connecting to the doghouse 4, the fastener 2 connects the two parts together.

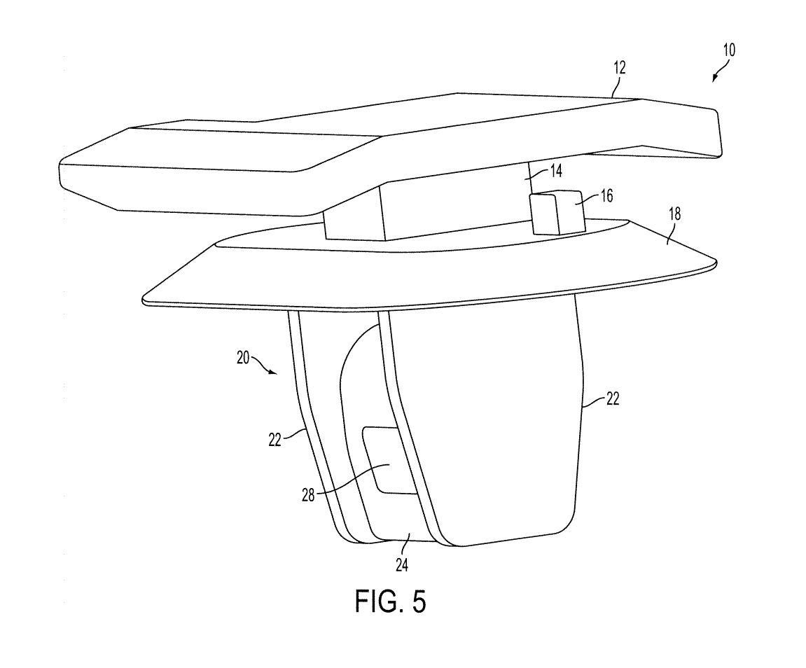

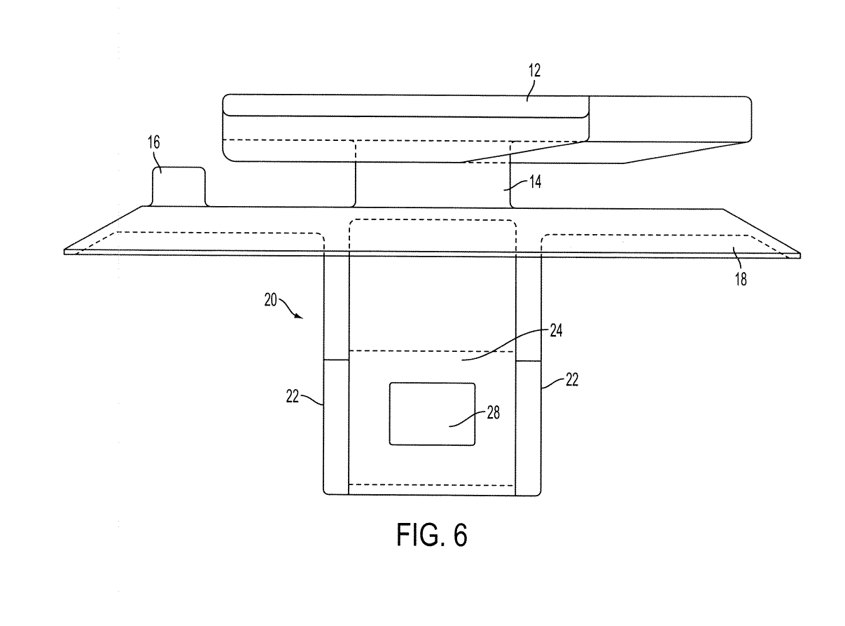

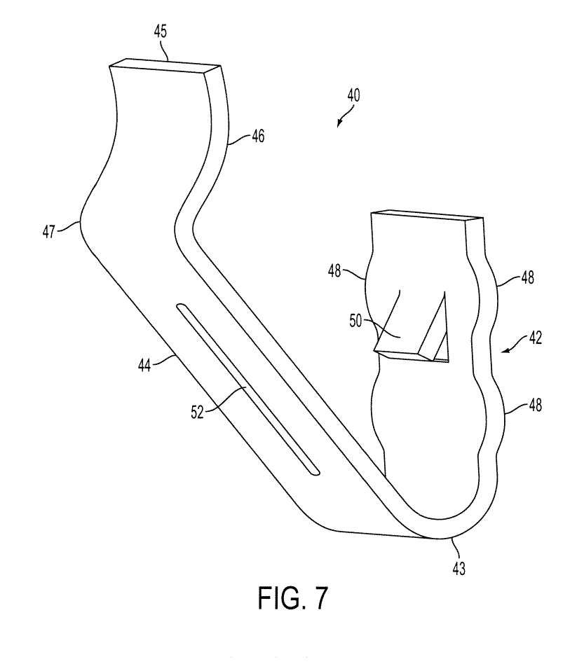

FIGS. 5 and 6 show the base part 10 and FIG. 7 illustrates one of the pair of arms 40 which connect to the base part 10 to form the assembled fastener 2. The base part is made of plastic and the arms are made of metal. As shown in FIGS. 5 and 6, the base part includes a connection part 12. In the exemplary embodiment, the connection part is a flange 12 which connects to the doghouse 4. However, other connection configurations are also contemplated. Projecting downwardly from the flange 12 is a spacer 14. The spacer 14 spaces the concave disk 18 from the flange 12 and allows the flange 12 to connect with the doghouse 4 as shown in FIG. 1.

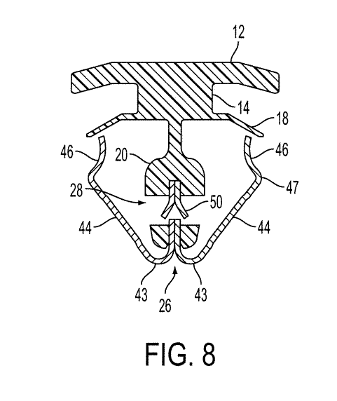

The base part 10 further includes a concave disk 18 which serves in combination with the arms 40 to secure the panel to the fastener 2, as described above and shown in FIG. 1. FIG. 8 is a cross-sectional view of the fastener 2 taken through line I of FIG. 3 and shows the arms 40 and their ends 45 opposing the concave disk 18. Since the concave disk 18 extends in a direction towards the panel 6 which is being held, it is put under a force by the panel 6. That is, the panel 6 tends to push the concave disk 18 upwards toward the flange 12 and the concave disk 18 pushes back toward the arms 40. This helps to create a seal between the concave disk 18 and the panel 6. A tab 16 extends from a top side of the concave disk for proper positioning of the fastener 2 in the doghouse 4, as can be seen in FIG. 1.

The fastener 2 further includes a body 20 which extends downwardly from the concave disk 18. The body includes a pair of rails 22 and a center portion 24 between the rails 22. As shown in FIG. 8, the center portion 24 is relatively narrow at a portion adjacent to the concave disk 18 and has a wider portion farther away from the concave disk 18. A bottom end of the center portion 24 has an opening 26 (as shown in FIG. 5) through which the arms 40 can be inserted. The body portion 20 also includes a cutout 28 to receive tabs 50 of the arms 40. The cutout 28 extends perpendicularly to the opening 26 and extends through the entirety of the center portion 24 of the base 10. As can be seen in FIG. 8, in-line with the opening 26 and above the cutout 28 is a recess 27. The recess 27 receives ends of the insertion portions 42 of the arms 40 to help secure them in place.

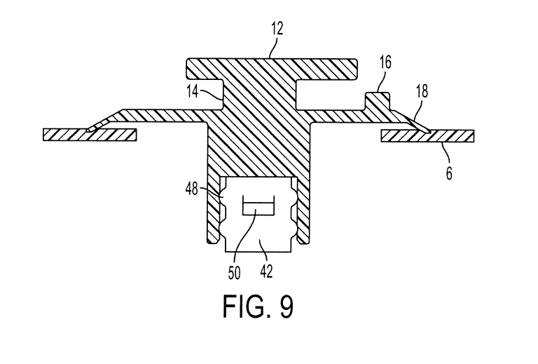

One of the arms 40 is shown in more detail in FIG. 7. As shown in FIG. 7, the arm 40 includes an insertion portion 42, an angled portion 44 and a concave portion 46. The insertion portion 42 is inserted into the opening 26 of the fastener. The insertion portion 42 of the exemplary embodiment includes two pairs of knobs 48. The knobs 48 increase the width of the arms 40 so that they contact the plastic base part 10 and help retain the insertion portion 42 in the plastic base part 10 through a frictional fit. The frictional fit between the tabs 48 and the base part 10 can be clearly seen in FIG. 9, which is a cross-sectional view of the fastener 2 through line II in FIG. 4.

The insertion portion 42 further includes a tab 50. When the arms 40 are assembled with the base part 10, the tab 50 extends into the cutout 28. This is best seen in FIG. 8. As can be appreciated by the drawing of FIG. 8, the tabs prevent the arms from pulling out of the base part 10.

Adjacent to the insertion portion is the angled portion 44. The angled portion 44 includes a bead 52 running along its length. The bead 52 comprises a depression on the outside surface of the arm. There is a corresponding projection (not shown) on the inside surface of the arm 40. The bead strengthens the angled portion 44 of the arm 40, which in turn allows for consistent insertion and extraction forces over multiple cycles.

The arm 40 further includes a concave portion 46 and an end 45. A peak 47 occurs between the angled portion 44 and the concave portion 46. The concave portion 46 forces the fastener 2 into the panel 6. Further, the shape of the concave portion 46 and the angled portion 44 serve to provide the difference between the insertion and extraction forces.

In exemplary embodiments of the invention, the arms are made of stainless steel or spring steel.

As can be appreciated by looking at FIG. 7, the arm 40 of the exemplary embodiment has a limited number of bends. The insertion portion 42 and the angled portion 44 are connected by bend 43 and the angled portion 44 and the concave portion 46 are connected by the peak 47 which is also a bent portion. Thus, the arm 40 has three portions connected by two bends. The concave portion 46 also is processed to form the concavity. Bending a metal arm excessively can result in weakening the arm. Additionally, more bending requires more involved manufacturing. Accordingly, the limited number of bends provided by the arm 40 of the exemplary embodiment of the present application helps to allow the arm 40 to maintain its strength and provide consistent insertion and extraction forces over multiple cycles.

In order to assemble the fastener 2, the two arms 40 are inserted into the base part 10. Specifically, the insertion portion 42 is inserted into the opening 26 at a bottom of the body 20. As the insertion portion 42 is inserted into the body 20, the tab 50 is initially compressed. Then, as the tab 50 enters the cutout 28, it expands to secure the arm in the body portion 20. As shown in FIG. 9, the knobs 48 provide additional attachment force through a friction fit with sides of the opening. The knobs 48 also help to prevent vibration or side-to-side movement of the arms 40 when they are inserted into the base part 10.

As can be seen in FIG. 4, the arms 40 are placed back-to-back with the retention portions 42 of the arms 40 being adjacent to one another and contacting one another at least at portions thereof. The opening 26 and the recess 27 are sized to correspond to the size of the back-to-back arms 40 and hold the insertion portions securely therein. In the exemplary embodiment of FIG. 5, ends of the tabs 50 are spaced from the body 20. It is also contemplated that the tabs are dimensions such that their ends contact the body part at the cutout 28.

A fastener 2 according to the exemplary embodiment provides a stable connection of the arms 40 with the base part 10. Particularly, the arms 40 are not prone to swinging back and forth (direction “A” in FIG. 3) to hit the body part 20. Particularly, the arms 40 are not prone to shifting from side-to-side (direction “B” in FIG. 4) and hitting the rails 22 of the body 20. This stable connection helps to provide consistent insertion and extraction forces by keeping the arms 40 in the same relative position to the base part 10 through different insertions and among multiple parts.

The fastener 2 according to the exemplary embodiment also allows insertion and extraction of the fastener from the panel 6, with the insertion effort being much lower than the extraction effort. This makes the fastener 2 easy to install and not prone to pulling out of the panel, yet still allows the fastener 2 to be removable for service purposes.

Exemplary embodiments of the present invention have been described for illustrative purposes, and those skilled in the art will appreciate that various modifications, additions and substitutions are possible, without departing from the scope and spirit of the invention as disclosed in the accompanying claims.

What is claimed is:

1. A fastener comprising:
a base part and a pair of arms connected to the base part;
the base part includes a wide portion and a body portion which is narrower than the wide portion;
the body portion has a first end at the wide portion and extends from the wide portion and terminates at a second end;
the second end of the body part includes an insertion opening;
the arms including an insertion portion which is inserted into the insertion opening and connect the arms to the body portion,
the arms further comprising an angled portion, the angled portion extending at an angle from the insertion portion, towards the wide portion and outwardly from the body portion;
the arms additionally including a concave portion adjacent to the angled portion and further extending toward the wide portion, a peak being defined between the angled portion and the concave portion.

2. The fastener of claim 1, wherein the body portion further includes a cutout extending perpendicular to the opening;
wherein the arms further include tabs at the insertion portion; and
wherein the tabs extend into the cutout to secure the arms to the base part.

3. The fastener of claim 2, wherein the insertion portions of the arms further include knobs which create portions of increased width.

4. The fastener of claim 3, wherein the knobs have a frictional fit with the body portion.

5. The fastener of claim 2, wherein the wide portion is a concave disk.

6. The fastener of claim 2, wherein the base part further includes a connection portion and a spacer spacing the side portion from the connection portion, the spacer being narrower than the wide portion and the connection portion.

7. The fastener of claim 6, further comprising a panel secured between the arms and the wide portion of the base part and a connecting part connected to the connection portion of the base part.

8. The fastener of claim 7, wherein the connection portion and the connecting part are connected in a doghouse configuration.

9. The fastener of claim 2, wherein the arms are made of metal and the base part is made of plastic.

10. The fastener of claim 2, wherein the base part further includes a recess which lies along the same axis as the insertion opening and is located at an opposite side of the cutout with respect to the insertion opening; and
wherein ends of the insertion portions are located in the recess.

11. A fastener comprising:
a base part and a pair of arms;
wherein the base part comprises:
a connection part;
a spacer portion extending downwardly from the connection part, the spacer portion being narrower than the connection part;
a disk at a bottom end of the spacer, the disk being wider than the spacer;
a body portion extending downwardly from the umbrella, the body portion comprising a pair of side rails and a center portion and including an opening at its bottom end, the body portion further comprising a cutout in a direction perpendicular to the downward direction;
wherein each of the arms comprises an insertion portion inserted into the opening, an angled portion extending from the insertion portion at an angle towards the disk and outwardly from the body portion, and a concave portion adjacent to the angled portion and closer to the disk than the angled portion;
wherein a peak being defined between the angled portion and the concave portion.

12. The fastener of claim 11, wherein the insertion portion of each arm includes a tab which extends into the cutout and prevents removal of the arms from the base part.

13. The fastener of claim 12, wherein the insertion portion of each arm further includes knobs which create portions of increased width and create a friction fit with the body portion of the base part.

14. The fastener of claim 13, wherein the base part is made of plastic and the arms are made of metal.

15. The fastener of claim 11, wherein the cutout is perpendicular to the opening.

16. The fastener of claim 11, wherein in the disk is concave and further comprising a panel secured between the concave portion of the arms and the concave disk portion of the base part.
